(19) United States
(12) Patent Application Publication
(10) Pub. No.: US 2003/0122502 A1
(43) Pub. Date: Jul. 3, 2003

(54) Light emitting diode driver

(76) Inventors: Bernd Clauberg, Schaumburg, IL (US); Robert A. Erhardt, Schaumburg, IL (US)

Correspondence Address: PHILIPS ELECTRONICS NORTH AMERICAN CORP, 580 WHITE PLAINS RD, TARRYTOWN, NY, 10591, US

(21) Appl. No.: 10/037,490

(22) Filed: Dec. 28, 2001

(51) Int. Cl. H05B 41/36

(52) U.S. Cl. 315/291; 315/100

(57) ABSTRACT

A LED driver is disclosed. The LED driver includes a high frequency inverter and an impedance circuit. The high frequency inverter operates to produce a high frequency voltage source whereby the impedance circuit directs a flow of alternating current through a LED array including one or more anti-parallel LED pairs, one or more anti-parallel LED strings, and/or one or more anti-parallel LED matrixes. A transistor can be employed to divert the flow of the alternating current from the LED array, or to vary the flow of the alternating current through LED array.

### BACKGROUND OF THE INVENTION

1. Field of the Invention

The present invention generally relates to light emitting diode (“LED”) arrays. The present invention specifically relates to a LED array powered by an alternating current supplied by a high frequency inverter circuit, and LED arrays controlled by impedance array that may be switching to accomplish dimming and switching functions.

2. Description of the Related Art

LEDs are semiconductor devices that produce light when a current is supplied to them. LEDs are intrinsically DC devices that only pass current in one polarity and historically have been driven by DC voltage sources using resistors to limit current through them. Some controllers operate devices in a current control mode that is compact, more efficient than the resistor control mode, and offers “linear” light output control via pulse width modulation. However, this approach only operates one array at a time and can be complex.

LEDs can be operated from an AC source if they are connected in an “anti-parallel” configuration as shown by patents WO98/02020 and JP11/330561. Such operation allows for a simple method of controlling LED arrays but which operate from a low frequency AC line. However, this approach employs large components and no provision is given for controlling the light output.

The present invention addresses the problems with the prior art.

### SUMMARY OF THE INVENTION

The present invention is a light emitting diode driver. Various aspects of the present invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the invention is a LED driver comprising a LED array, an inverter, and an impedance circuit. The LED array has an anti-parallel configuration. The inverter is operable to provide an alternating voltage at a switching frequency. The impedance circuit is operable to direct a flow of an alternating current through said LED array in response to the alternating voltage. In one aspect, the impedance circuit includes a capacitor and the LED array includes an anti-parallel LED pair, an anti-parallel LED string and/or anti-parallel LED matrix coupled in series to the capacitor. In another aspect, a transistor is coupled in parallel to the LED array with the transistor being operable to control (e.g., varying or diverting) the flow of the alternating current through the LED array.

The foregoing form as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a block diagram of a LED driver in accordance with the present invention;

FIG. 2 illustrates a first embodiment of the LED driver of FIG. 1 in operation with a first embodiment of a LED array in accordance with the present invention;

FIG. 3 illustrates the LED driver of FIG. 1 in operation with a second embodiment of a LED array in accordance with the present invention;

FIG. 4 illustrates a second embodiment of the LED driver of FIG. 1 in operation with a third embodiment of a LED array in accordance with the present invention;

FIG. 5 illustrates the second embodiment of the LED driver of FIG. 1 in operation with a fourth embodiment of a LED array in accordance with the present invention;

FIG. 6 illustrates a third embodiment of the LED driver of FIG. 1 in operation with a fifth embodiment of a LED array in accordance with the present invention;

FIG. 7 illustrates a first embodiment of an illumination system in accordance with the present invention; and

FIG. 8 illustrates a second embodiment of an illumination system in accordance with the present invention.

### DETAILED DESCRIPTION OF THE PRESENTLY PREFERRED EMBODIMENTS

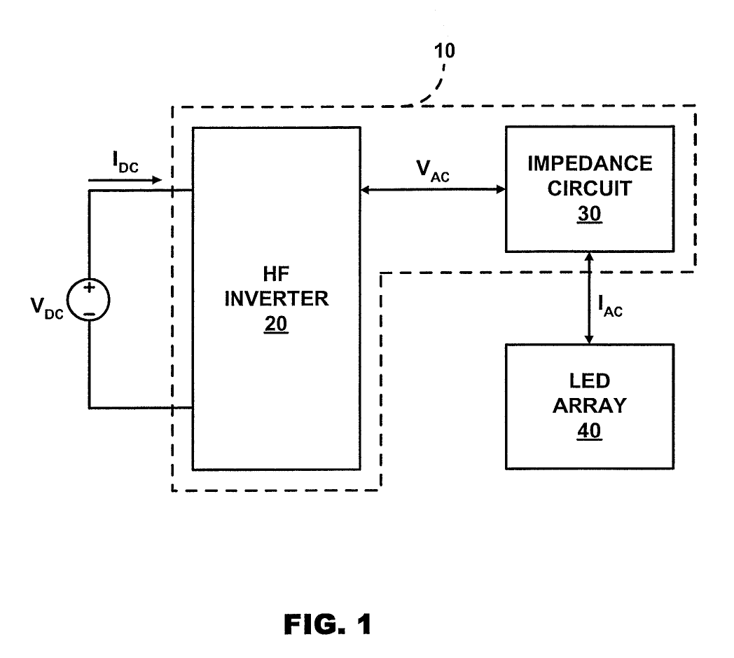

FIG. 1 illustrates a LED driver 10 in accordance with the present invention for driving a LED array 40. LED driver 10 comprises a high frequency (“HF”) inverter 20, and an impedance circuit 30. In response to a direct current I_{DC} from a direct voltage source V_{DC}, HF inverter 20 communicates an alternating voltage V_{AC} to impedance circuit 30 at a switching frequency (e.g., 20 kHz to 100 kHz), which in turn communicates an alternating current I_{AC} to LED array 40. HF inverter 20 allows a compact and efficient method to control the current to LED array 40. At high frequencies, the current limiting components become compact in size. HF inverter 20 also allows for an efficient current control from direct voltage source V_{DC}. Forms of HR inverter 20 include, but are not limited to, a voltage fed half bridge, a current fed half bridge, and a current fed push pull. Techniques known in the art can be employed to use frequency modulation to control output current which can be implemented to further improve the regulation of the proposed invention.

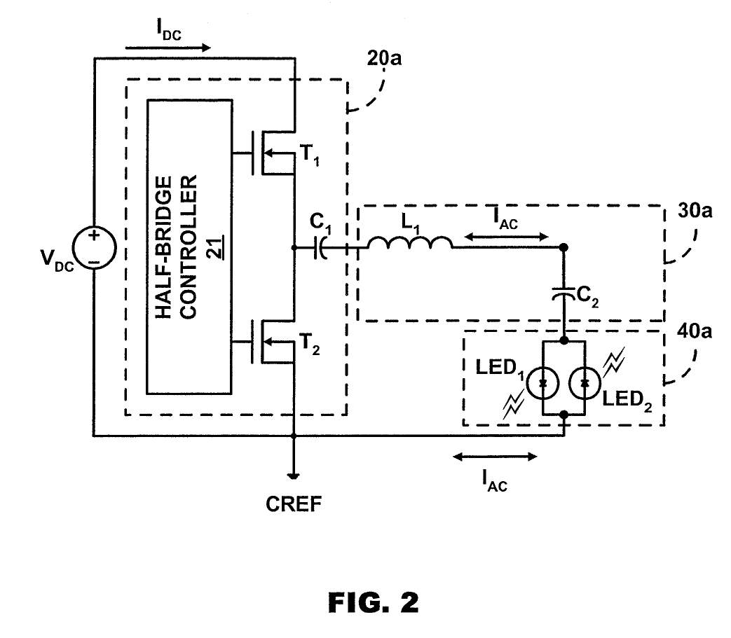

FIG. 2 illustrates a first embodiment of LED driver 10 (FIG. 1) in accordance with the present invention. A HF inverter 20a includes a half-bridge controller 21 for controlling a half-bridge consisting of a transistor T₁ and a transistor T₂ in the form of MOSFETs. HF inverter 20a conventionally activates and deactivates transistor T₁ and transistor T₂ in an alternating inverse manner to produce a DC pulsed voltage (not shown) between transistor T₁ and transistor T₂. The DC pulsed voltage is dropped across a capacitor C₁ to produce a voltage square wave (not shown) to an impedance circuit 30a.

An impedance circuit 30a includes an inductor L₁ and a capacitor C₂ coupled to capacitor C₁ in series. Inductor L₁ and capacitor C₂ direct a flow of alternating current I_{AC} through a LED array 40a having a light emitting diode LED₁ and a light emitting diode LED₂ coupled in anti-parallel (i.e., opposite polarizations). Alternating current I_{AC} flows through light emitting diode LED₁ when alternating current I_{AC} is in a positive polarity. Alternating current I_{AC} flows through light emitting diode LED₂ when alternating current I_{AC} is in a negative polarity. Impedance elements L₁ and C₂ are connected with light emitting diode LED₁ and light emitting diode LED₂ in a “series resonant, series loaded” configuration. In this configuration, circulating current can be minimized and “zero voltage switching” of transistor T₁ and transistor T₂ can be realized resulting in an efficient and compact circuit.

A further benefit of this configuration is the ability to vary the current through the LEDs by varying the frequency of the half bridge. In such a configuration as frequency increases, current through the LEDs will generally decrease and as frequency decreases, current will increase. If a frequency control is added to the half bridge, variable light output from the LEDs can be realized.

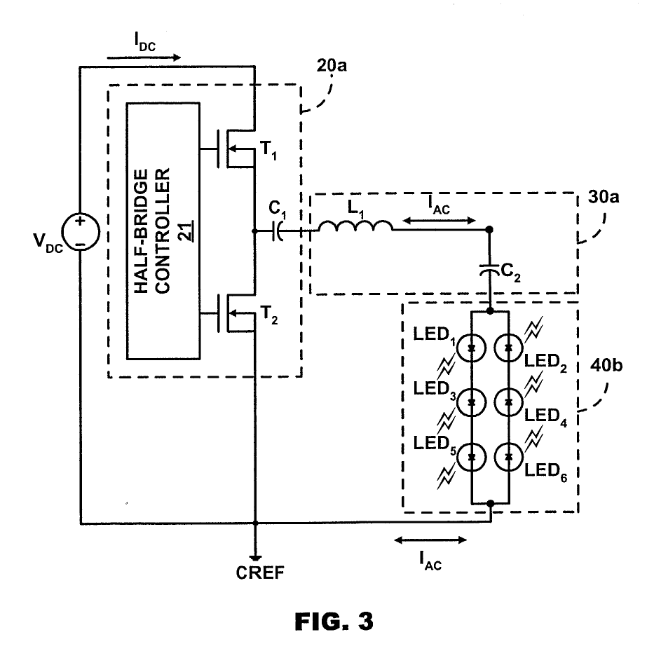

FIG. 3 illustrates HF inverter 20a (FIG. 2) and impedance circuit 30a (FIG. 2) driving an LED array 40b having a LED strings in place of single LEDs connected in “anti-parallel configuration. Alternating current I_{AC} flows through a light emitting diode LED₁, a light emitting diode LED₃ and a light emitting diode LED₅ when alternating current I_{AC} has a positive polarity. Conversely, alternating current I_{AC} flows through a light emitting diode LED₂, a light emitting diode LED₄ and a light emitting diode LED₆ when alternating current I_{AC} has a negative polarity. In alternative embodiments, the LED strings can have differing numbers of LEDs in series as requirements warrant and may be connected in electrically equivalent configurations or in “matrix configuration” as would be known by those skilled in the art.

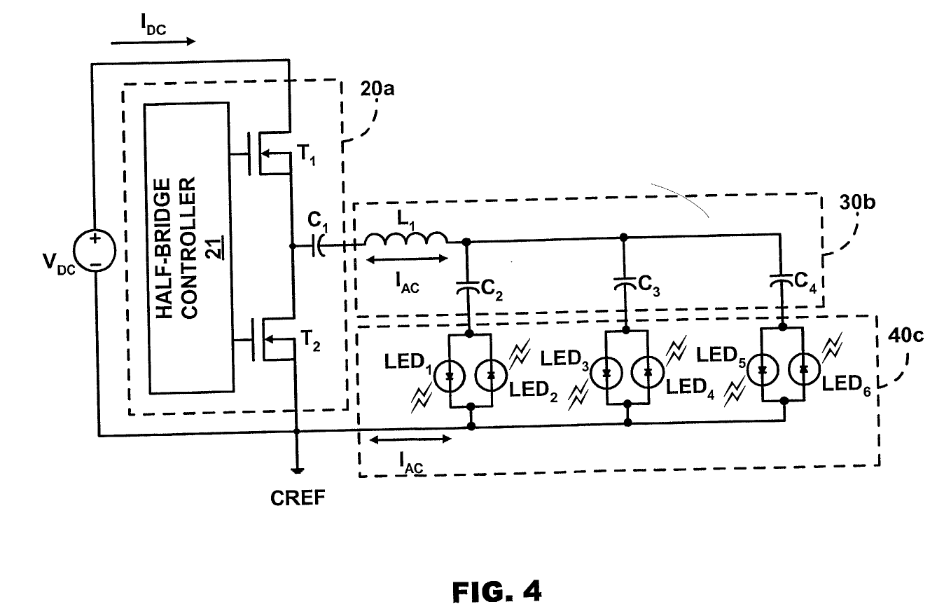

FIG. 4 illustrates a second embodiment of LED driver 10 (FIG. 1). An impedance circuit 30b includes inductor L₁ coupled in series to a parallel coupling of capacitor C₂, a capacitor C₃ and a capacitor C₄. Impedance circuit 30b directs a flow of alternating current I_{AC} through LED array 40c. An anti-parallel coupling of light emitting diode LED₁ and light emitting diode LED₂ is coupled in series with capacitor C₂. An anti-parallel of coupling light emitting diode LED₃ and light emitting diode LED₄ is coupled in series with capacitor C₃. An anti-parallel coupling of light emitting diode LED₅ and light emitting diode LED₆ is coupled in series with capacitor C₄. Divided portions of alternating current I_{AC} flow through light emitting diode LED₁, light emitting diode LED₃ and light emitting diode LED₅ when alternating current I_{AC} is in a positive polarity. Divided portions of alternating current I_{AC} flow through light emitting diode LED₂, light emitting diode LED₄ and light emitting diode LED₆ when alternating current I_{AC} is in a negative polarity. The capacitance values of capacitor C₂, capacitor C₃ and capacitor C₄ are identical whereby alternating current I_{AC} is divided equally among the anti-parallel LED couplings.

Capacitor C₂, capacitor C₃, and capacitor C₄ can be low cost and compact surface mounted type capacitors and may be mounted directly to LED array 40c as a subassembly. By driving pairs of LEDs in this manner the driving scheme has the advantage that if one LED fails “open” only one pair of LEDs will go dark as opposed to a whole string as can be the case with other driving schemes. While LED array 40c is shown to consist of three pairs of anti-parallel connected LEDs one skilled in the art can see that anti-parallel connected LED “strings” as illustrated in FIG. 3 could also be connected in the same fashion as could any number of LED pairs/strings/matrixes with a corresponding number of current splitting capacitors. Furthermore, if differing levels of current were desired in different LED pairs/strings/matrixes this can be accomplished by choosing capacitor values of different capacitance inversely proportional to the ratio of current desired.

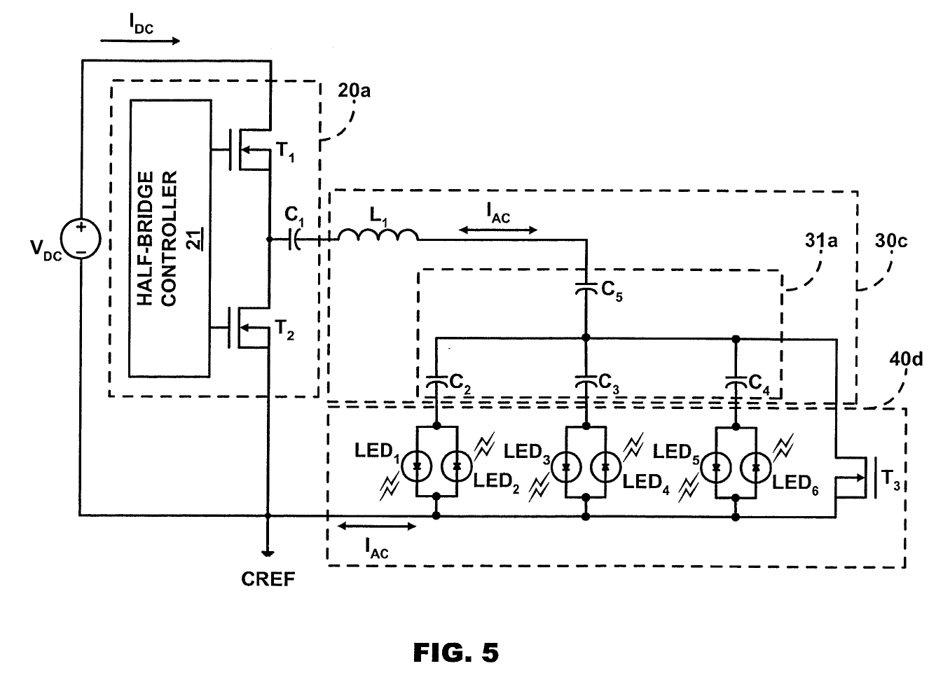

FIG. 5 illustrates a third embodiment of LED driver 10 (FIG. 1). An impedance circuit 30c includes inductor L₁ coupled in series to a capacitor C₅, which is coupled in series to a parallel coupling of capacitor C₂, capacitor C₃ and capacitor C₄. Impedance circuit 30c directs a flow of alternating current I_{AC} through of LED array 40d. An anti-parallel coupling of light emitting diode LED₁ and light emitting diode LED₂ is coupled in series with capacitor C₂. An anti-parallel of coupling light emitting diode LED₃ and light emitting diode LED₄ is coupled in series with capacitor C₃. An anti-parallel coupling of light emitting diode LED₅ and light emitting diode LED₆ is coupled in series with capacitor C₄. A switch in the form of a transistor T₃ is coupled in parallel to the anti-parallel LED couplings. Those having ordinary skill in the art will appreciate other forms of switches that may be substituted for transistor T₃.

Divided portions of alternating current I_{AC} can flow through light emitting diode LED₁, light emitting diode LED₃ and light emitting diode LED₅ when alternating current I_{AC} is in a positive polarity. Divided portions of alternating current I_{AC} can flow through light emitting diode LED₂, light emitting diode LED₄ and light emitting diode LED₆ when alternating current I_{AC} is in a negative polarity.

The capacitance values of capacitor C₂, capacitor C₃ and capacitor C₄ can be proportioned to divide the alternating current I_{AC} into whatever ratios are desired for the individual LED pairs. An operation of transistor T₃ serves to divert alternating current I_{AC} from the anti-parallel LED couplings to thereby turn the LEDs off. Capacitor C₅ is included in this representation to minimize the effective impedance change seen by the half bridge 20a and hence the change in current level I_{AC} when transistor T₃ is switched on and off, but the circuit can also operate with a series resonant capacitance made up of only capacitor C₂, capacitor C₃ and capacitor C₄. It is also possible to substitute LED strings as represented in FIG. 3 or matrix connections of LEDs in place of the LED pairs.

While three LED pairs and capacitors are shown in this representation for demonstration purposes it should be obvious to one skilled in the art that any number of LED pairs, LED strings, and/or LED matrices can be used with suitable capacitors and drive from the half bridge 20a and can be switched with transistor T₃.

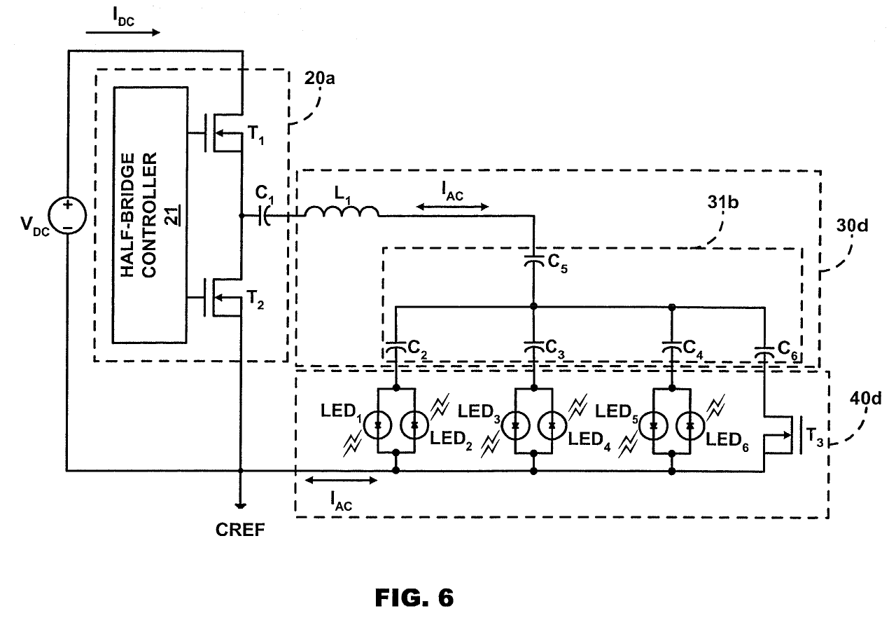

FIG. 6 illustrates a fourth embodiment of LED driver 10 (FIG. 1). An impedance circuit 30d includes inductor L₁ coupled in series to a capacitor C₅, which is coupled in series to a parallel coupling of capacitor C₂, capacitor C₃, capacitor C₄ and capacitor C₆. Impedance circuit 30d directs a flow of alternating current I_{AC} through of LED array 40d. An anti-parallel coupling of light emitting diode LED₁ and light emitting diode LED₂ is coupled in series with capacitor C₂. An anti-parallel of coupling light emitting diode LED₃ and light emitting diode LED₄ is coupled in series with capacitor C₃. An anti-parallel coupling of light emitting diode LED₅ and light emitting diode LED₆ is coupled in series with capacitor C₄. Transistor T₃ is coupled series to capacitor C₆.

Divided portions of alternating current I_{AC} can flow through light emitting diode LED₁, light emitting diode LED₃ and light emitting diode LED₅ when alternating current I_{AC} is in a positive polarity. Divided portions of alternating current I_{AC} can flow through light emitting diode LED₂, light emitting diode LED₄ and light emitting diode LED₆ when alternating current I_{AC} is in a negative polarity. The capacitance values of capacitor C₂, capacitor C₃ and capacitor C₄ can be proportioned to divide the alternating current I_{AC} into whatever ratios are desired for the individual LED pairs. An operation of transistor T₃ serves to reduce the ampere level of the divided portions of alternating current I_{AC} through the anti-parallel LED couplings by diverting current via capacitor C₆.

It is also possible to substitute LED strings as represented in FIG. 3 or LED matrixes connections in place of the LED pairs.

While three LED pairs and capacitors are shown in this representation for demonstration purposes, those skilled in the art will appreciate that any number of LED pairs, LED strings, or LED matrices can be used with suitable capacitors and drive from the half bridge 20a and that the amplitude of current through these can be switched with transistor T₃ and suitable capacitance C₆.

Those having ordinary skill in the art will further appreciate that multiple levels of illumination can be realized for a given LED array through the use of combinations of switching schemes demonstrated in FIGS. 5 and 6, and through the use of multiple switches and capacitors configured as in FIG. 6. If additional capacitors and switches are configured as taught by C₆ and T₃ of FIG. 6, then multiple illumination levels can be accomplished. If a switching transistor is added as taught by transistor T₃ from FIG. 5, an on/off function can be added as well.

In alternative embodiments, further “linear” dimming control could be added to either of the configurations as taught by FIGS. 5 and 6 if transistor T₃ in either of them were to be switched in a “pulse width modulated” fashion. If transistor T₃ were switched in such a manner, light output could be controlled linearly from the maximum and minimum levels determined by “full on” and “full off” states of the transistor T₃ through all light levels in between as a function of the duty cycle of the on time of the transistor T₃.

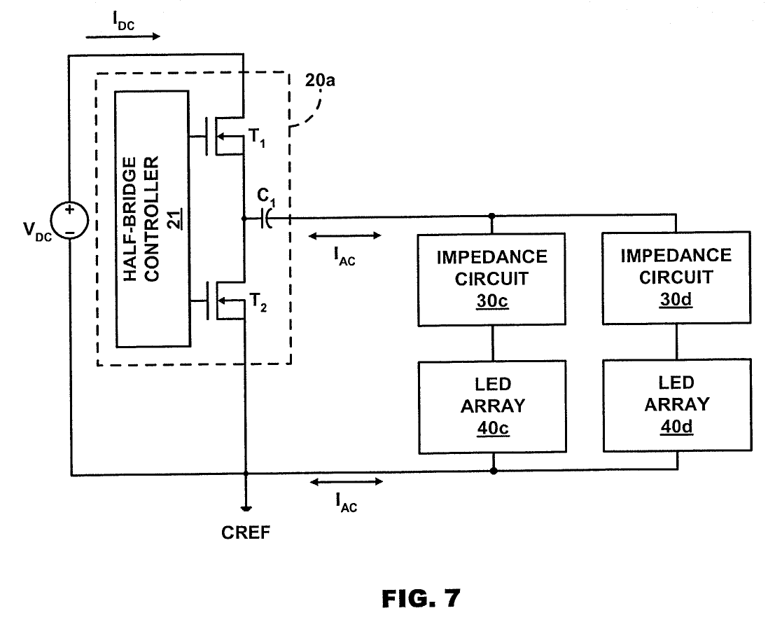

FIG. 7 illustrates a first embodiment of an illumination system in accordance with the present invention that combines on/off switching features as demonstrated in FIG. 5 with amplitude control features as demonstrated in FIG. 6. An automobile rear lighting system is an example of an application for such a requirement. In an automobile rear lighting system, an on/off requirement is used for the turn signal function and two levels of light output are used for the tail light and brake light functions.

HF inverter 20, impedance circuit 30c, and LED array 40d constitutes a turn signaling device whereby an operation of transistor T₃ as previously described herein in connection with FIG. 5 facilitates a flashing emission of light from LED array 40d. HF inverter 20, impedance circuit 30d, and LED array 40d constitutes a brake signaling device whereby an operation of transistor T₃ as previously described herein in connection with FIG. 6 facilitates an alternating bright/dim emission of light from LED array 40d. In this manner, a single half bridge driving stage can be used to control two sets of LEDs independently of each other with varying degrees of illumination.

While FIG. 7 is shown demonstrating one half bridge operating two sets of LED arrays, those having ordinary skill in the art will appreciate that any number of arrays of varying configuration can be connected and operated independently of each other through the control schemes shown the accompanying figures and previously described.

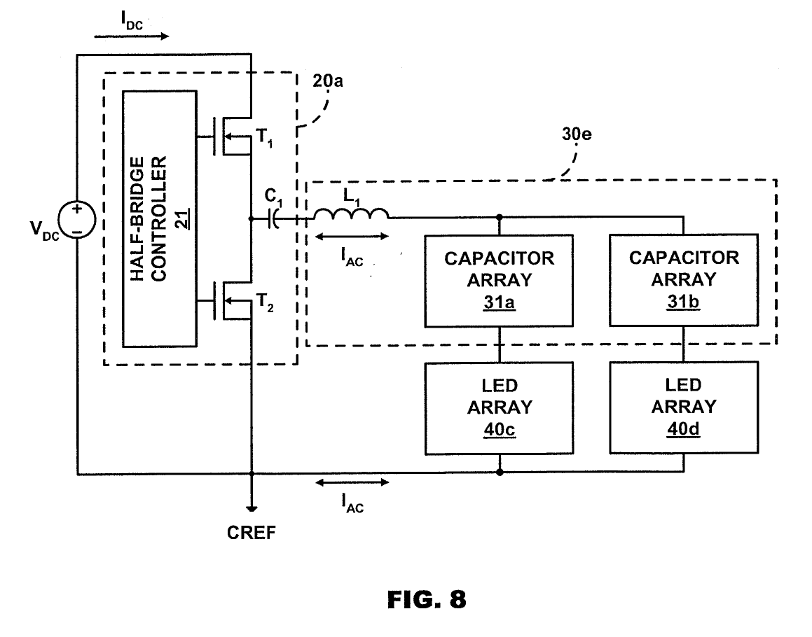

FIG. 8 illustrates a second embodiment of an illumination system in accordance with the present invention that combines on/off switching features as demonstrated in FIG. 5 with amplitude control features as demonstrated in FIG. 6 that can be used as an automobile rear lighting system. An impedance circuit 30e includes inductor L₁ coupled in series to a capacitive array 31a consisting of capacitor C₂, capacitor C₃, capacitor C₄ and capacitor C₅ as taught by the description of FIG. 5. Inductor L₁ is further coupled in series to a capacitive array 31b consisting of capacitor C₂, capacitor C₃, capacitor C₄, capacitor C₅ and capacitor C₆ as taught by the description of FIG. 6. HF inverter 20, impedance circuit 30e, and LED array 40d constitutes a turn signaling device whereby an operation of transistor T₃ as previously described herein in connection with FIG. 5 facilitates a flashing emission of light from LED array 40d. HF inverter 20, impedance circuit 30e, and LED array 40d constitutes a brake signaling device whereby an operation of transistor T₃ as previously described herein in connection with FIG. 5 facilitates an alternating bright/dim emission of light from LED array 40d. In this embodiment, a single inductor L₁ is used to minimize the size and cost of the controlling circuit.

In the present invention described herein in connection with FIGS. 1-8, those having ordinary skill in the art will appreciate HF inverter 20 and embodiments thereof combine the benefits of small size and high efficiency. Additionally, impedance circuit 30, LED array 40 and embodiments therefore utilize variable frequency, “linear” light output control based on a simple multiple array capability. Furthermore, LED array 40d and variations thereof allow for “step” light output and on/off switching control of multiple LED from a single driver. This type of control can be useful in operating running/stop/turn signals on an automobile or stop/caution/go signals of a traffic light among other uses.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

1. A device, comprising:
a LED array having an anti-parallel configuration;
an inverter operable to provide an alternating voltage at a switching frequency; and
an impedance circuit operable to direct a flow of an alternating current through said LED array in response to the alternating voltage.

2. The device of claim 1, wherein said LED array includes a switch operable to control a flow of the alternating current through said LED array.

3. The device of claim 1, wherein:
said impedance circuit includes a first capacitor coupled in series to said LED array; and
said LED array includes an LED pair, a pair of LED strings or a LED matrix.

4. The device of claim 3, wherein said impedance circuit further includes an inductor coupled in series between said inverter and said impedance circuit.

5. The device of claim 3, wherein said LED array further includes a switch operable to vary or divert a flow of the alternating current through said LED array.

6. The device of claim 3, wherein:
said impedance circuit further includes a second capacitor coupled in series to said first capacitor; and
said LED array further includes a switch operable to vary or divert a flow of the alternating current through said LED array.

7. A device, comprising:
a LED array having an anti-parallel configuration;
an inverter operable to provide an alternating voltage; and
an impedance circuit operable to direct a flow of an alternating current through said LED array in response to the alternating voltage,
wherein said LED array includes a switch operable to control a flow of the alternating current through said LED array.

8. A device, comprising:
a LED array having an anti-parallel configuration;
means for providing an alternating voltage; and
means for controlling a flow of an alternating current through said LED array in response to the alternating voltage.

9. A method of illuminating an LED array having an anti-parallel configuration, comprising:
operating an inverter to provide an alternating voltage; and
operating an impedance circuit to direct a flow of an alternating current through the LED array in response to the alternating voltage.

10. The method of claim 9, further comprising:
operating a switch to selectively control the flow of the alternating current through the one or more pairs of LEDs.
